(19) United States
(12) Patent Application Publication
(10) Pub. No.: US 2026/0368459 A1
(43) Pub. Date: Nov. 19, 2026

(54) MAGNETIC CARD READER AND ELECTRONIC PAYMENT TERMINAL WITH SUCH A MAGNETIC CARD READER

(71) Applicant: BANKS AND ACQUIRERS INTERNATIONAL HOLDING, SURESNES (FR)

(72) Inventors: Vincent HERNANDEZ, SURESNES (FR); Xavier LAMBERT, SURESNES (FR); Lilian VASSY, SURESNES (FR); Olivier FABREGOULE, SURESNES (FR); Jérôme ANDRE, SURESNES (FR); Christophe CURINIER, CHARPEY (FR)

(21) Appl. No.: 19/141,114

(22) PCT Filed: Dec. 22, 2023
(86) PCT No.: PCT/EP2023/087769

§ 371 Date: Jun. 19, 2025

(30) Foreign Application Priority Data
Dec. 23, 2022 (FR) FR2214361

(51) Int. Cl. G06K 7/08

(52) U.S. Cl. CPC G06K 7/087

(57) ABSTRACT

A magnetic card reader including an electronic card for receiving and processing data from a magnetic card, the electronic card including at least one microprocessor, and a magnetic reading head configured to read data contained in at least one magnetic track of a magnetic card and to transmit this data to the electronic card. The electronic card includes at least one solder pad to which the magnetic read head is soldered. One of the at least one solder pads is a safety pad electrically connected to the microprocessor, the safety pad being disposed entirely between the electronic card and the magnetic reading head. An electronic payment terminal including such a magnetic card reader.

### TECHNICAL FIELD

The invention relates to the field of magnetic card readers and to electronic payment terminals comprising such magnetic card readers.

### BACKGROUND

A magnetic card is an electronic card with at least one magnetic track on which data is stored by magnetic recording. The magnetic track on this magnetic card can thus be read by a magnetic reading head so as to obtain the information stored in this magnetic card and possibly transmit it to an electronic card which can then process this data. Magnetic cards are used, for example, as bank cards, car park access cards, identification cards or access cards to secure rooms.

In order to obtain a reading of a magnetic track of a magnetic card by a magnetic card reader, when the magnetic card is passed through the reader, a magnetic reading head is in contact with the magnetic track of the magnetic card and the data read is received and processed by an electronic card. For example, the magnetic reading head is connected to the electronic card via a flexible circuit.

In order to secure the reading of the magnetic track, it is known to protect or shield the tracks on the electronic card, or even the flexible circuit, through which the data read by the magnetic reading head passes. However, data recovery is still possible upstream of the electronic card, for example by creating a bypass circuit between the magnetic read head and the electronic card.

There is therefore a need to reinforce the safety of the magnetic stripe reading function in a magnetic card reader, in order to prevent any recovery of data read by the magnetic reading head.

### SUMMARY

One of the aims of the invention is to provide a magnetic card reader in which the safety of the reading function is improved while being simple in structure.

To this end, the object of the invention is a magnetic card reader comprising:
an electronic card for receiving and processing data from a magnetic card, the electronic card comprising at least one microprocessor,
a magnetic read head configured to read data contained in at least one magnetic track of a magnetic card and to transmit this data to the electronic card, the electronic card comprising at least one solder pad to which the magnetic reading head is soldered,
one of the said at least one solder pad is a safety pad electrically connected to the microprocessor, the safety pad being disposed entirely between the electronic card and the magnetic reading head.

Thus, because the magnetic read head is soldered to the electronic board, it is not possible to produce a bypass between the magnetic read head and the electronic board without unsoldering the magnetic read head from the electronic board. In addition, the safety pad electrically connected to the microprocessor makes it possible to detect removal of the magnetic read head from the electronic board when the safety pad is unsoldered. Lastly, because the safety pad is located entirely between the electronic board and the magnetic reading head, it is not possible to act on this safety pad from the outside without unsoldering the magnetic reading head from the electronic board. As a result, the safety of the reading function is improved while remaining simple in structure.

Depending on other optional features of the magnetic card reader, taken alone or in combination:
The magnetic reading head is metallic. The magnetic reading head is therefore simple and economical to produce.
The magnetic reading head is grounded to the electronic board. This reduces the risk of electrostatic discharge.
The safety pad is disposed at a distance of at least 0.1 mm from an outer periphery of the magnetic reading head, preferably between 0.1 and 0.4 mm, more preferably equal to 0.15 mm. Thus, even allowing for a tolerance in the relative positioning of the magnetic reading head and the electronic card before the magnetic reading head is fixed to the electronic card by soldering, the safety pad is invisible from the outside after soldering.

The magnetic card reader has a connection to a battery configured to supply the microprocessor with electricity. This ensures that the detection of the magnetic reading head being withdrawn from the electronic card when the safety pad is unsoldered is detected by the microprocessor, because the microprocessor is powered at least by an element inside the reader, namely the battery. As a result, the safety of the reading function is further improved.
The magnetic card reader includes a connection to an external electricity source configured to supply electricity to the microprocessor. This avoids consuming battery power when it is not required, i.e. when the reader is connected to an external power source.
The magnetic reading head is fixed solely by soldering to the electronic board, preferably is fixed solely by surface soldering to the electronic board. This simplifies manufacture, since the method of fixing the magnetic read head to the electronic card corresponds to the method of making the security slot.
The electronic board comprises a plurality of solder pads to which the magnetic read head is soldered. This means that the magnetic read head can be fixed securely and easily.
The distance between the safety pad and the other solder pad(s) is greater than 0.17 mm, preferably greater than 0.3 mm, more preferably equal to 0.35 mm. This eliminates the risk of an electrical connection or discharge between the safety pad and the other soldering pad(s).
The magnetic card reader includes positioning means, which are configured to position the magnetic reading head and the electronic card relative to each other. This simplifies manufacture, as the magnetic reading head and the electronic card are positioned relative to each other when the safety pad is welded.
The positioning means comprise positioning tabs carried by the magnetic reading head, and positioning holes in the electronic board, which receive the positioning tabs. This makes it easy to position the magnetic read head on the electronic board before the soldering operation. This makes manufacturing easier.

The invention also relates to an electronic payment terminal comprising a magnetic card reader as previously described.

According to an optional feature of the electronic payment terminal:
The electronic payment terminal comprises a smart card reader.

Lastly, the invention relates to a method of disabling a magnetic card reader as described above, during which:
cyclically, the microprocessor measures the electrical potential of the electrical connection to the magnetic reading head via the safety pad,
when the measured potential is different from that of the earth of the electronic card, the microprocessor disables the magnetic card reader.

In this way, the microprocessor simply detects the removal of the magnetic reading head from the electronic card. As a result, the safety of the reading function is improved.

According to an optional feature of the disabling method:

When the power supply to the microprocessor is interrupted and then reactivated, the microprocessor disables the magnetic card reader. In this way, cutting off the power supply to the microprocessor so that it does not detect the removal of the magnetic reading head does not enable the magnetic reading head to be unsoldered, for example to provide a bypass between the magnetic reading head and the electronic card, then the magnetic reading head to be re-soldered to the magnetic card, and finally the microprocessor to be re-powered in order to simulate or re-establish normal operation of the magnetic card reader. This further improves the safety of the reading function.

### BRIEF DESCRIPTION OF THE FIGURES

The invention will be better understood on reading the following description, which is given by way of example only and with reference to the attached drawings in which:

FIG. 1 is a perspective view of an electronic payment terminal comprising a magnetic card reader according to one embodiment;

FIG. 2 is a schematic perspective view of an electronic card and some of the components of the magnetic card reader of the electronic payment terminal shown in FIG. 1;

FIG. 3 is a schematic perspective view of a detail of the electronic card without the other components of the magnetic card reader of the electronic payment terminal shown in FIG. 1;

FIG. 4 is a schematic top view of a detail of FIG. 2.

### DETAILED DESCRIPTION

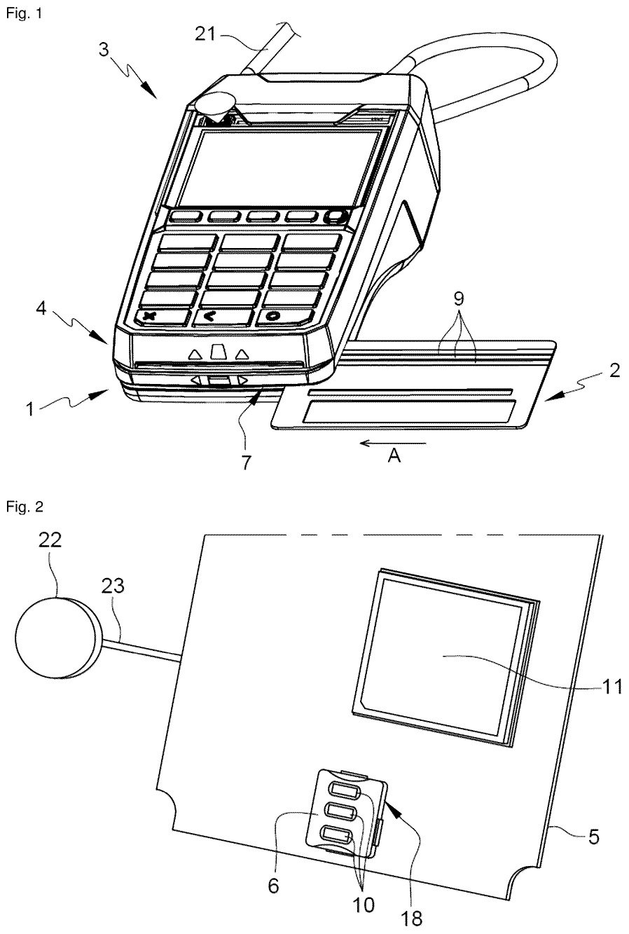

With reference to FIGS. 1 to 4, we describe below an embodiment of a reader 1, for a magnetic card 2, according to the invention, integrated into an electronic payment terminal 3 according to the invention. In FIGS. 1 to 4, elements similar to those in the previous Figures are designated by identical references.

The electronic payment terminal 3 shown in FIG. 1 thus comprises the magnetic card reader 1 for the magnetic card 2 and a chip card reader 4, which is conventional. The electronic payment terminal 3 has two side edges, a top edge and a bottom edge. The upper and lower edges refer to the usual orientations in which an electronic payment terminal 3 is used. Thus, the upper edge corresponds to the distal edge, i.e. the edge furthest from the user when using the electronic payment terminal 3, and the lower edge corresponds to the proximal edge, i.e. the edge closest to the user when using the electronic payment terminal 3. In this case, in addition to the conventional location of the smart card reader 4 at the bottom edge, the reader 1 for a magnetic card 2 is also located at the bottom edge of the electronic payment terminal 3. According to other embodiments, the terminal is of a type other than an electronic payment terminal 3, for example a car park access control terminal, an identification terminal, or an access control terminal for a secure room.

The reader 1 for a magnetic card 2 comprises in particular an electronic card 5, a magnetic reading head 6 and passage zone 7 for a magnetic card 2. In this case, the terminal being an electronic payment terminal 3, the magnetic card 2 is a payment card. It comprises three magnetic tracks 9 for magnetic data storage. In other embodiments, the magnetic card 2 comprises a different number of magnetic tracks 9, for example one, two or four.

The magnetic read head 6, illustrated in particular in FIG. 4, is configured to read data contained in at least one magnetic track 9 on the magnetic card 2 and to transmit this data to the electronic card 5 for processing. In this case, as the electronic card 2 comprises three magnetic tracks 9, the magnetic read head 6 is a box carrying three gaps 10 each configured to read one of the magnetic tracks 9 on the magnetic card 2. In this example, the magnetic read head 6 is metallic. In particular, the magnetic read head 6 comprises a metal casing 6′.

The passage zone 7 of the magnetic card 2 is formed by a slot made in the lower edge of the electronic payment terminal 3. This passage zone 7 is the one in which the magnetic card 2 is intended to slide, for example in the reading direction A shown in FIG. 1, when a user wishes to use it on the electronic payment terminal 3. Typically, the magnetic reading head 6 opens into the passage zone 7 to enable the data contained in at least one of the magnetic tracks 9 of the magnetic card 2 to be read by means of the gaps 10. To enable reading, the magnetic tracks 9 of the magnetic card 2 are pressed against the gaps 10 carried by the magnetic reading head 6, for example by guide means in the passage zone.

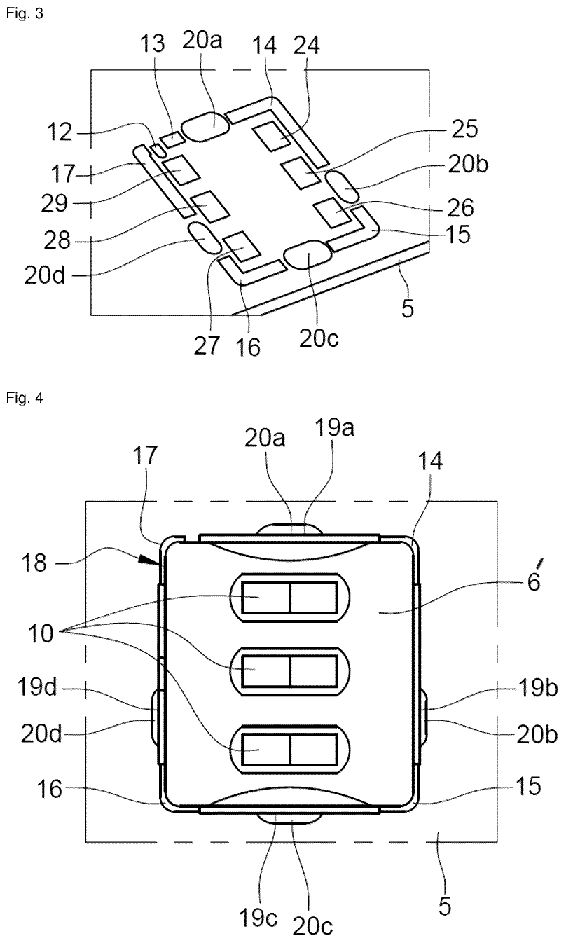

The electronic card 5 is configured to receive and process data from the magnetic card 2, this data being read and transmitted by the magnetic reading head 6. The electronic card 5 comprises at least one microprocessor 11, shown in FIG. 2. As shown in FIG. 3, the electronic card 5 has at least one solder pad 12, 13, 14, 15, 16, 17 to which the metal casing 6′ of the magnetic reading head 6 is soldered, which is deliberately not shown in FIG. 3 so that the at least one solder pad 12, 13, 14, 15, 16, 17 can be seen. In this example, the electronic board 5 has a plurality of solder pads 12, 13, 14, 15, 16, 17 to which the metal casing 6′ of the magnetic read head 6 is soldered. For example, the metal casing 6′ of the magnetic read head 6 is fixed solely by soldering to the electronic board 5. More precisely in this example, the metal casing 6′ of the magnetic read head 6 is fixed solely by surface soldering to the electronic board 5. Such an assembly is also known as a SMD for “surface mounted component”.

One of said at least one solder pad 12, 13, 14, 15, 16, 17 is a safety pad 12 electrically connected to the microprocessor 11. Typically, such an electrical connection is made by a track in the thickness of the electronic board 5. Furthermore, in this example, the magnetic reading head 6 is at earth of the electronic board 5. In other words, the safety pad 12 is at a potential of 0 volts with respect to the earth of the electronic board 5. The safety pad 12 is also arranged entirely between the electronic board 5 and the magnetic reading head 6. Thus, as shown in FIG. 2 and FIG. 4, the safety pad 12 is not visible from the outside. Thus, the safety solder pad 12 does not protrude from the outside of the magnetic reading head 6 so that it cannot be accessed without removing the magnetic reading head 6, thus preventing any attempt to hack the magnetic reading head 6. If the circuit is opened, i.e. if the safety solder pad 12 is unsoldered from the casing 6′ of the magnetic read head 6, the microprocessor 11 detects the removal of the magnetic read head 6 and engages a secure mode, for example by deleting all the information contained in the memory of the terminal 3. In this way, the magnetic read head 6 protects itself.

Furthermore, the distance between the safety pad 12 and the other solder pad(s) 13, 14, 15, 16, 17 is greater than 0.17 mm, preferably greater than 0.3 mm, more preferably equal to 0.35 mm. In addition, the safety pad 12 is located at a distance of at least 0.1 mm from an outer periphery 18 of the magnetic reading head 6, preferably between 0.1 and 0.4 mm, more preferably equal to 0.15 mm.

The reader 1 for a magnetic card 2 also includes positioning means, which are configured to position the magnetic reading head 6 and the electronic card 5 relative to each other. In this example, the positioning means comprise positioning tabs 19a, 19b, 19c, 19d carried by the magnetic reading head 6, and positioning holes 20a, 20b, 20c, 20d in the electronic card 5, which receive the positioning tabs 19a, 19b, 19c, 19d. For example, as shown in FIG. 3, the positioning means comprise four oblong positioning holes 20a, 20b, 20c, 20d, which receive four positioning tabs 19a, 19b, 19c, 19d.

The electronic payment terminal 3, in this example the magnetic card reader 1, comprises a connection 21 to an external electricity source configured to supply the microprocessor 11 with electricity. The electronic payment terminal 3 also includes a battery 22. Thus, the card reader 1 for a magnetic card 2 comprises a connection 23 to the battery 22 configured to supply the microprocessor 11 with electricity, in this example when the external electricity source does not supply the microprocessor 11 with electricity by means of the connection 21 to the external electricity source. For example, battery 22 is a battery, in this example a CR2032 type battery. In this example, the battery 22 is arranged in a housing remote from the electronic board 5 and is electrically connected to the electronic board 5. According to a variant, the battery 22 is arranged on the electronic board 5.

Data is transferred to the electronic board 5 by means of coils wound on the base of the air gaps 10, in this example three coils. The electronic board 5 thus comprises specific soldering pads 24, 25, 26, 27, 28, 29, in this example six specific solder pads 24, 25, 26, 27, 28, 29, to which the coils wound on the base of the air gaps 10 are soldered. It should be noted that the welding pads 12, 13, 14, 15, 16 and 17 are separate from the specific welding pads 24, 25, 26, 27, 28 and 29.

A method for decommissioning such a magnetic card reader 1 comprises, for example, the following steps:
cyclically, the microprocessor 11 measures the electrical potential of the electrical connection to the reading head 6 via the safety pad 12,
when the measured potential is different from that of the earth of the electronic card 5, the microprocessor 11 disables the magnetic card reader 1.

Furthermore, in this example, the method of disabling such a magnetic card reader 1 comprises the following step:
when the power supply to the microprocessor 11 is interrupted and then reactivated, the microprocessor 11 disables the magnetic card reader 1.

The invention is not limited to the embodiments shown and other embodiments will be clear to the person skilled in the art.

### LIST OF REFERENCES

1: magnetic card reader
2: magnetic card
3: electronic payment terminal
4: smart card reader
5: electronic card
6: magnetic reading head
6′: metal casing of the reading head
7: magnetic card swipe zone
9: magnetic track
10: air gap
11: microprocessor
12: soldering pad, safety pad
13, 14, 15, 16, 17: sealing pad
18: outer circumference of magnetic read head 6
19a, 19b, 19c, 19d: positioning tabs
20a, 20b, 20c, 20d: locating holes
21: connection
22: battery
23: connection
24, 25, 26, 27, 28, 29: specific soldering pads

1. reader for a magnetic card comprising:
an electronic card for receiving and processing data from a magnetic card, the electronic card comprising at least one microprocessor,
a magnetic read head configured to read data contained in at least one magnetic track of a magnetic card and to transmit this data to the electronic card,
the electronic card comprising at least one solder pad to which the magnetic reading head is soldered,
wherein one of the said at least one solder pad is a safety pad electrically connected to the microprocessor, the safety pad being disposed entirely between the electronic card and the magnetic reading head.

2. The reader according to claim 1, wherein the magnetic reading head is grounded to the electronic card.

3. The reader according to claim 1, wherein the safety pad is disposed at a distance of at least 0.1 mm from an outer periphery of the magnetic reading head.

4. The reader according to claim 1, further comprising a connection to a battery configured to supply the microprocessor with electricity.

5. The reader according to claim 1, wherein the magnetic reading head is fixed solely by soldering to the electronic cardboard

6. The reader according to claim 1, wherein the electronic card comprises a plurality of the solder pads to which the magnetic reading head is soldered.

7. The reader according to claim 6, wherein a distance between the safety pad and another of the solder pads is greater than 0.17 mm.

8. The reader according to claim 1, further comprising positioning means, which are configured to position the magnetic reading head and the electronic card relative to each other.

9. The reader according to claim 8, wherein the positioning means comprise:
positioning tabs carried by the magnetic reading head, and
positioning holes in the electronic card, which receive the positioning tabs.

10. An electronic payment terminal comprising the reader for the magnetic card according to claim 1.

11. A method of disabling a magnetic card reader according to claim 1, comprising:
cyclically, the microprocessor measures an electrical potential of the electrical connection to the magnetic reading head via the safety pad,
when the measured potential is different from that of the earth of the electronic card, the microprocessor disables the magnetic card reader.

12. The method according to claim 11, wherein, when a power supply to the microprocessor is interrupted and then reactivated, the microprocessor disables the magnetic card reader.

13. The reader according to claim 3, wherein the distance is between 0.1 and 0.4 mm, more preferably equal to 0.15 mm.

14. The reader according to claim 3, wherein the distance is equal to 0.15 mm.

15. The reader according to claim 5, wherein the magnetic reading head is fixed to the electronic card by surface soldering.

16. The reader according to claim 7, wherein the distance is greater than 0.3 mm, more preferably equal to 0.35 mm.

17. The reader according to claim 7, wherein the distance is equal to 0.35 mm.
